(19) United States
(12) Patent Application Publication
(10) Pub. No.: US 2012/0200479 A1
(43) Pub. Date: Aug. 9, 2012

(54) Liquid Crystal Display Driver

(75) Inventor: Erik Fossum Færevaag, Bergen (NO)

(73) Assignee: Energy Micro AS, Oslo (NO)

(21) Appl. No.: 13/501,520

(22) PCT Filed: Oct. 14, 2010
(86) PCT No.: PCT/IB10/02773

§ 371 Date: Apr. 12, 2012

Related U.S. Application Data
(60) Provisional application No. 61/251,591, filed on Oct. 14, 2009.

(51) Int. Cl. G09G 3/34

(52) U.S. Cl. 345/84

(57) ABSTRACT

An LCD driver for driving an LCD having a plurality of segments, wherein each segment is enabled by an RMS voltage exceeding a predefined turn-on threshold is disclosed. The LCD driver includes a control module, a power supply module, a reference module and a selector module. The control module is configured to output at least a clock, a first control, a second control and a third control. The power supply module is configured to receive a supply voltage and the first control, and output the supply voltage to the reference module. The reference module is configured to receive the supply voltage and the second control, and output a plurality of duty cycled and buffered reference voltages. The selector module is configured to receive the buffered reference voltages and the third control, and output one or more of the buffered reference voltages to one or more of the segments of the LCD according to a predefined sequence.

### CROSS-REFERENCE TO RELATED APPLICATION

This application claims priority to U.S. Provisional Application Ser. No. 61/251,591, filed on Oct. 14, 2009.

### BACKGROUND

1. Technical Field

The present disclosure relates to liquid crystal displays (LCDs), and more particularly, to devices and methods for driving LCDs with minimized power consumption and reduced component area.

2. Description of the Related Art

There are ongoing efforts in the field of electronics and computing to reduce power consumption, minimize production costs, decrease product size and optimize overall efficiency. Such efforts are increasingly being directed toward examining the individual components and subcomponents of various hardware and electronics, so as to determine if power can be conserved. Many of such components or subcomponents include liquid crystal displays (LCDs) and LCD drivers.

There are several different types of LCD drivers that are currently used to drive any one of a number of different types of LCD panels with widely varying degrees of integration, including those that are situated directly on an integrated circuit, or on-chip. Until recent years, the power consumed by a typical LCD driver has been relatively small when compared to the power consumed by the overall system. Since then, however, there have been several advancements in energy conservation techniques at the system level and the overall decrease in power consumption. Now, upon comparison, the power or current consumed by sub-system level components, such as a typical LCD driver, is relatively large, for instance, 10 μA or more, and exhibits a need for improvement, for instance, reducing the current draw to approximately 500 nA or so.

Accordingly, there is a need for an improved LCD driver that collectively incorporates and integrates various energy saving techniques and strategies to provide optimum performance at minimum power. Among other things, there is a need for an LCD driver that occupies less on-chip space and consumes a fraction of the current required by currently existing low power LCD drivers.

### SUMMARY OF THE DISCLOSURE

In satisfaction of the aforenoted needs, a liquid crystal display (LCD) driver and method for driving an LCD are disclosed.

An LCD driver for driving an LCD having a plurality of segments, wherein each segment is enabled by a root mean square (RMS) voltage exceeding a predefined turn-on threshold is disclosed. The LCD driver includes one or more control modules, one or more power supply modules, one or more reference modules and one or more selector modules. The control module is configured to output at least a clock, a first control, a second control and a third control. The power supply module is configured to receive a supply voltage and the first control, and output the module-internal supply voltage. The reference module is configured to receive the supply voltage provided by the power supply module and the second control, and output at a plurality of buffered voltages. The selector module is configured to receive the buffered reference voltages and the third control, and output one or more of the buffered reference voltages to one or more of the segments of the LCD according to a predefined sequence.

In a refinement, the power supply module is configured to make no adjustments to the supply voltage received.

In another refinement, the power supply module is configured to at least regulate, buck, or boost the supply voltage received.

In another refinement, the power supply module includes at least one storage device and one or more switches configured to selectively charge or discharge the storage device.

In another refinement, the storage device is a capacitor.

In another refinement, the power supply module includes at least one comparator configured to compare a magnitude of the supply voltage to a magnitude of an output of the power supply module.

In another refinement, the power supply module is configured to discharge the storage device and boost the supply voltage only when the magnitude of the supply voltage is less than the magnitude of the output of the power supply module.

In another refinement, the power supply module includes a clock generator configuration for charging the storage device.

In another refinement, the reference module includes a duty cycled resistor ladder.

In another refinement, the reference module includes a capacitive digital-to-analog converter (DAC).

In another refinement, the reference module includes an adaptive bias buffer.

In another refinement, the selector module includes a plurality of substantially small multiplexers.

In another refinement, the multiplexers are configured such that each multiplexer is associated with a pad interfacing with the segments of the LCD.

In yet another refinement, the selector module includes a digital control bus for transmitting the third control to each of the multiplexers.

A method for driving an LCD is also disclosed. The method comprises the steps of providing a clock and a supply voltage, generating a boosted voltage based on the clock and the supply voltage, the boosted voltage being greater in magnitude than the supply voltage, generating a plurality of reference voltages corresponding to the boosted voltage, storing a sample of the reference voltage, buffering the reference voltages, and selectively driving the reference voltages to the segments of the LCD according to a predefined sequence, the predefined sequence being configured such that an RMS voltage of the reference voltages received at the segments to be enabled is greater than the turn-on threshold, and the RMS voltage of the reference voltages received at the segments to be disabled is less than the turn-on threshold.

In a refinement, the step of generating a boosted voltage employs at least one capacitor and one or more switches configured to selectively charge or discharge the capacitor.

In another refinement, the step of generating a boosted voltage employs a comparator to compare a magnitude of the supply voltage to a magnitude of the boosted voltage, and discharges the capacitor to boost the supply voltage only when the magnitude of the supply voltage is less than the magnitude of the boosted voltage.

In another refinement, the reference voltages are generated using a duty cycled configuration of one or more resistors.

In another refinement, the reference voltages are generated using a capacitive digital-to-analog converter (DAC).

In another refinement, the reference voltages are selectively driven to the segments of the LCD via a plurality of substantially small multiplexers.

In yet another refinement, the multiplexers are configured such that each multiplexer is associated with a pad interfacing with the segments of the LCD.

Other advantages and features will be apparent from the following detailed description when read in conjunction with the attached drawings.

### BRIEF DESCRIPTION OF THE DRAWINGS

The disclosed liquid crystal display (LCD) driving apparatus and method are described more or less diagrammatically in the accompanying drawings wherein:

FIG. 1 is a schematic of an exemplary LCD driver that is constructed in accordance with this disclosure;

FIG. 2 is a schematic of a reference module of the LCD driver of FIG. 1;

FIG. 3 is a schematic of an exemplary booster module as applied to the LCD driver of FIG. 1;

FIG. 4 is a timing diagram illustrating exemplary operations of the booster module of FIG. 2;

FIG. 5 is a schematic of a selector module of the LCD driver of FIG. 1; and

FIG. 6 is a flow diagram of an exemplary method for driving an LCD.

It should be understood that the drawings are not necessarily to scale and that the embodiments are sometimes illustrated by graphic symbols, phantom lines, diagrammatic representations and fragmentary views. In certain instances, details which are not necessary for an understanding of this disclosure or which render other details difficult to perceive may have been omitted. It should be understood, of course, that this disclosure is not limited to the particular embodiments and methods illustrated herein.

### DETAILED DESCRIPTION OF THE DISCLOSURE

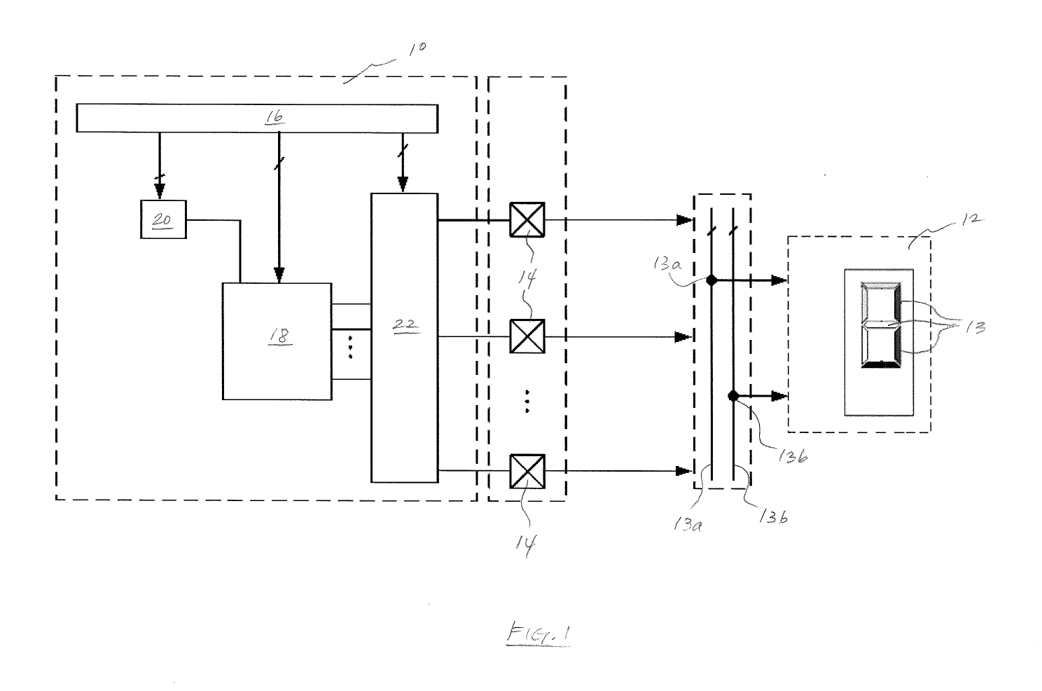

FIG. 1 illustrates an exemplary driver apparatus 10 as applied to an integrated circuit for driving a typical liquid crystal display (LCD) 12 comprising a plurality of segments 13. In particular, each segment 13 of the LCD 12 may be driven, or enabled and disabled, via an associated pad 14 or interface according to a voltage received across the segment 13, or across its respective segment and common nodes, lines, or buses 13a, 13b. For example, if the magnitude of a root mean square (RMS) voltage received between a particular segment node 13a and common node 13b is greater than a predefined threshold voltage for the segment 13, the segment 13 may be enabled, turned on, darkened in color, or the like. If, however, the magnitude of a voltage received across the segment node 13a and common node 13b is less than the predefined threshold voltage for the particular segment 13, the segment 13 may be disabled, turned off, transparent, or the like. Each segment 13 of an LCD 12 may also include several intermediate threshold levels that are predefined and distinguished to result in different degrees of brightness, darkness, transparency, and the like. In order to simultaneously enable and/or disable the individual segments 13 of the LCD 12, the LCD driver 10 of FIG. 1 may be used to selectively supply the enabling and/or disabling voltages to the respective segments 13 across the segment and common lines 13a, 13b, as shown.

As shown in FIG. 1, the LCD driver 10 apparatus may provide more energy efficient means for driving an LCD 12 by providing a duty cycled reference as well as an adaptively biased output stage. Specifically, the LCD driver 10 may be used to drive the lines 13a, 13b coupled to the individual pads 14, and thus, the segments 13 of the LCD 12, wherein each line 13a, 13b may be configured to carry a segment or common type of signal. Moreover, the LCD driver 10 may essentially include a control module 16, reference module 18, power supply module 20 and a selector module 22 that is coupled to the segment and common lines 13a, 13b. The control module 16 may essentially serve to distribute clocks and controls to the respective digital and analog modules 18, 20, 22 within the LCD driver 10. Furthermore, the control module 16 may be preprogrammed to output clock and controls according to any desired configuration and any sequence of events. Moreover, the frequency of the clocks and the sequencing of the controls provided by the control module 16 may be configured to operate the LCD driver 10 in a low power mode, or the like.

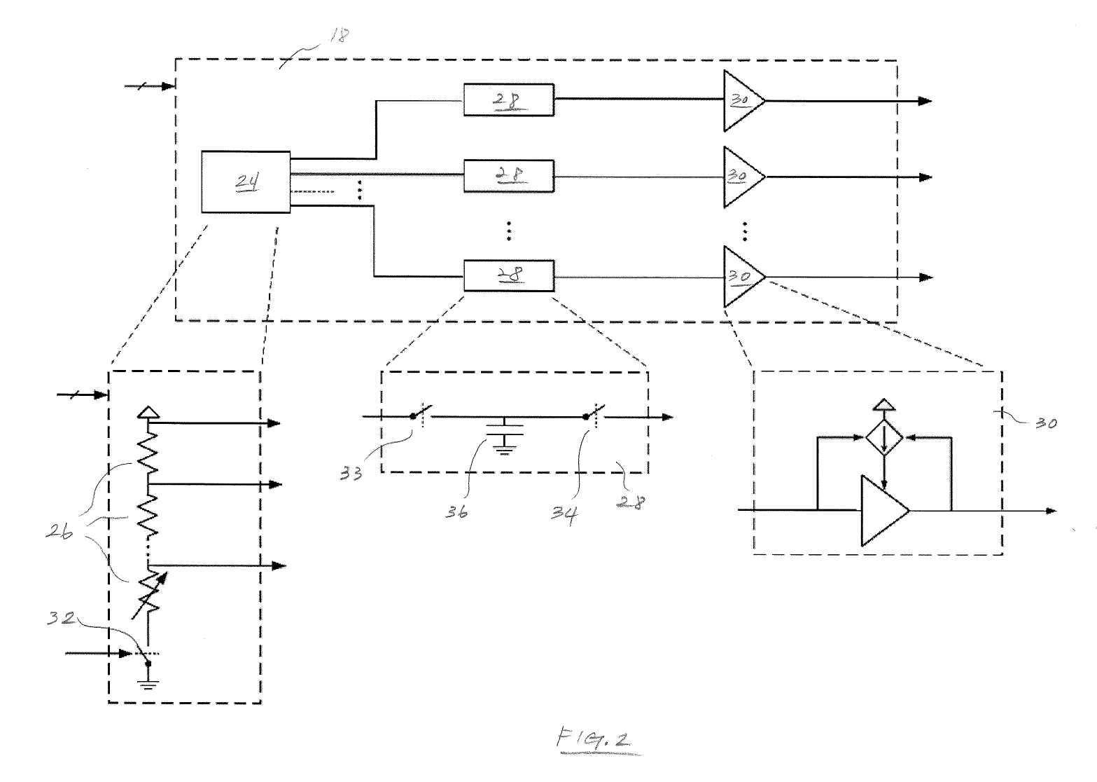

Referring now to FIG. 2, a reference module 18 for providing a plurality of buffered reference voltages is disclosed. In particular, the reference module 18 may receive the voltage supply provided by the power supply module 20, and according to a control provided by the control module 16, may further generate a plurality of buffered reference voltages to be output to, for instance, the selector module 22 of FIG. 1. The reference module 18 may include a reference generator 24, which provides reference voltages for the segments 13 of the LCD 12. Moreover, the reference generator 24 may comprise a series of resistors 26 arranged in a ladder configuration, capacitive divider, digital-to-analog converter (DAC), or the like, so as to provide any number of desired reference voltages therebetween. However, resistive voltage reference dividers may draw current even after components have settled, or when segments 13 of the LCD 12 have charged and/or refreshed. Accordingly, the power consumed by such a resistive voltage reference divider while maintaining a steady-state reference voltage may be greater than optimal.

In order to address and prevent such unnecessary waste of energy, the reference module 18 may employ a duty cycled and sampled reference system, being resistive, capacitive, or the like, wherein the reference generator 24 is enabled and consumes power only during certain instances of refreshing or updating the reference voltages. This may be accomplished using a series of sample and hold devices 28, buffers 30 and a series of switches 32-34, as shown, for example, in FIG. 2. During use, for instance, the reference generator 24 may initially be enabled by closing a first switch 32. Subsequently, each of the reference voltages that are tapped and output by the reference generator 24 may be sampled and held using second and third switches 33, 34 and a storage device 36 of the sample and hold device 28. Each resulting reference voltage may then be buffered by a respective buffer 30, or the like, so as to provide more output current and increase the drive strength thereof. Notably, the buffers 30 may comprise an adaptive bias buffer, or any other suitable relative current biasing means, so as to consume no more current than what is necessary to charge and maintain the output voltage. For even less power consumption, and as an alternative to the duty cycled configuration of FIG. 2, the reference module 18 may comprise a switched capacitor or a charge sharing digital-to-analog converter (DAC), not shown, which may consume current in the range of nano-amperes.

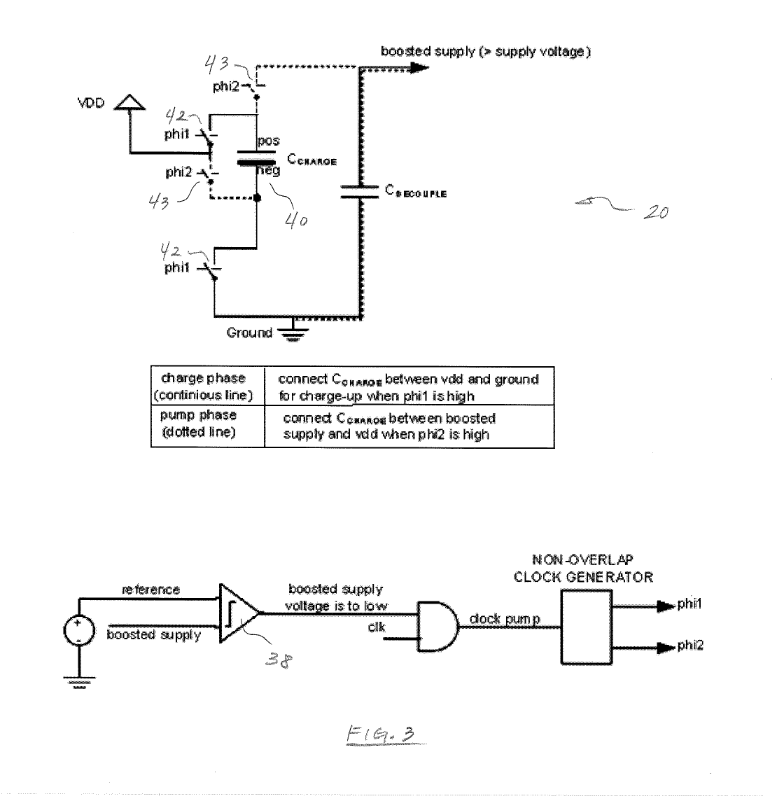

The power supply module 20 may serve to provide a supply current and/or voltage to the LCD driver 10. Moreover, in some embodiments, the power supply module 20 may include a wire or similar electrical connection means to provide a direct connection to one or more external and/or internal power sources. In other embodiments, the power supply module 20 may, for example, include means for decreasing, or bucking, an incoming supply voltage, means for increasing or boosting, an incoming supply voltage, or the like. Turning to FIG. 3, one exemplary power supply module 20 configured, for instance, as a booster module of the LCD driver 10 is disclosed in more detail. The booster module 20 may comprise an analog circuit for receiving a supply voltage input, and supplying a boosted output voltage for driving the subcomponents of the LCD driver 10 as well as the individual segments 13 of the LCD 12. Moreover, the booster module 20 may serve to output a voltage that is greater in magnitude than the voltage that is supplied to the integrated circuit upon which the LCD driver 10 may be situated. As shown, the booster module 20 may essentially include a comparator 38, or the like, and accompanying logic which may be configured to determine when the voltage output by the booster module 20 needs to be boosted, and further, to source a clock as a clock generator for feeding the output stage of the booster module 20 as needed. When the output voltage of the booster module 20 is determined to fall below a desired magnitude, charge may be provided or pumped from the supply voltage at the input and into the boosted output voltage. This may be accomplished using a storage device 40, such as a capacitor, or the like, and a series of switches 42, 43, as shown.

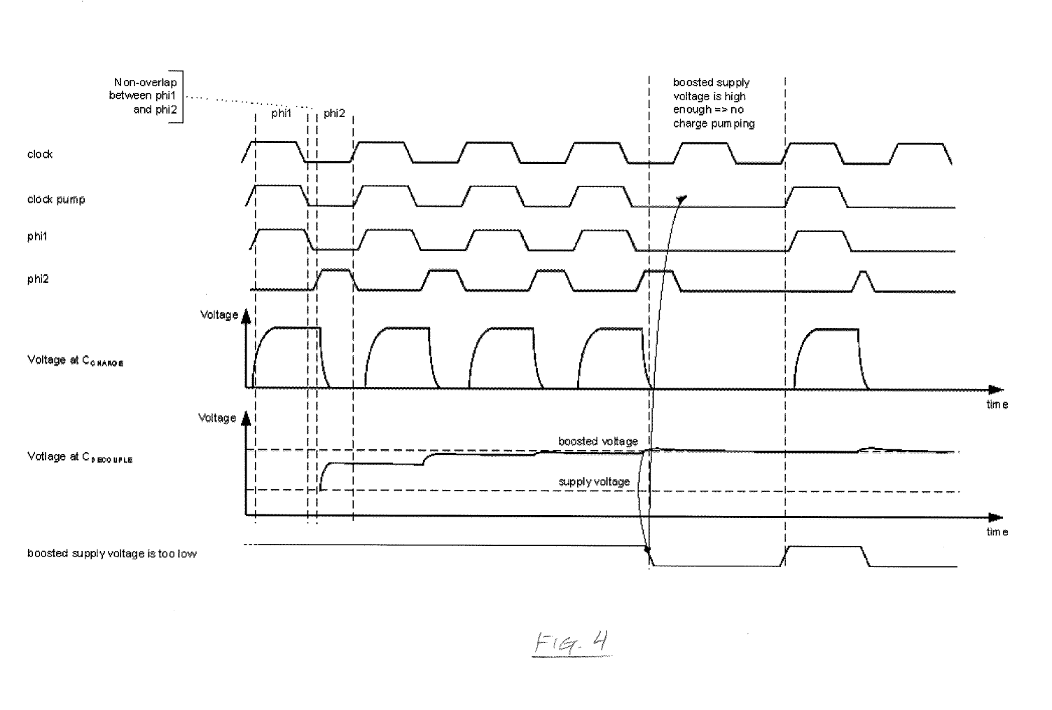

For instance, with reference to the timing diagram of FIG. 4, the storage device 40 of FIG. 3 may initially be charged between the input supply voltage and ground by closing the first set of switches 42 and leaving the second set of switches 43 open. When it is deemed necessary to boost the output voltage, the first set of switches 42 may be opened while the second set of switches 43 are closed so as to move charge to the boosted supply node, to provide a larger difference in potential between storage device 40 and the input supply voltage. Finally, when the comparator 38 determines that the output voltage has reached the desired magnitude, the first set of switches 42 may be closed while the second set of switches 43 may be opened. To further ensure that the storage device 40 does not discharge during the intermediate stages of switching and thus unnecessarily wasting excess energy, the switches 42, 43 may be prevented from being closed at the same time through a non-overlapping switch control scheme.

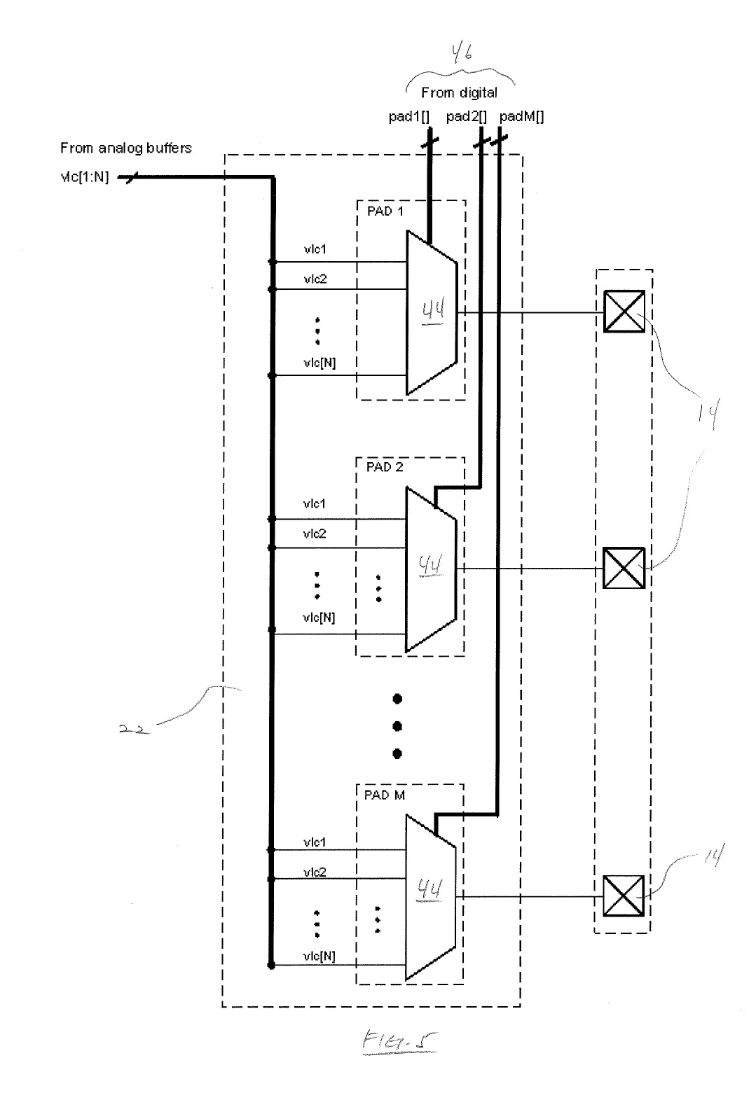

Turning to FIG. 5, a selector module 22 for selectively routing the buffered reference voltages provided by the reference module 18 is disclosed. Moreover, based on the controls provided by the control module 16, the selector module 22 may determine the specific buffered reference voltages, for instance, signals vlc1-vlc[N] of FIG. 5, to let through to the respective pads 14, and thus, the respective segments 13 of the LCD 12. The control module 16 may be configured to provide the selector module 22 with such controls according to a predefined sequence. In particular, the predefined sequence may be timed such that the resulting voltages received across each segment 13 appear to have RMS voltage that is either greater than a predefined threshold voltage of the segment 13 to enable the segment 13, or is less than the predefined threshold voltage of the segment 13 to disable the segment 13.

To output the necessary voltages to the respective segments 13 and pads 14 of the LCD 12, the selector module 22 may employ one large multiplexer, several smaller multiplexers 44, or the like. The controls generated by the control module 16 may be received at the selector module 22 by way of a digital control bus 46, or the like, which electrically couples to each multiplexer 44 of the selector module 22. Using one large multiplexer, however, may result in a large number of long on-chip analogs, which can take up a significant area of an integrated circuit, and further, complicate proper distributions thereof. Accordingly, as shown in FIG. 5, the selector module 22 may comprise a plurality of smaller multiplexers 44, wherein each multiplexer 44 may be disposed inside or proximate to an associated pad 14 and the buffered reference voltages are distributed around to the associated pad 14, for example, within the padding itself. Such a configuration minimizes the area allotted within an integrated circuit for incorporating the selector module 22 while simplifying the connections to an LCD 12.

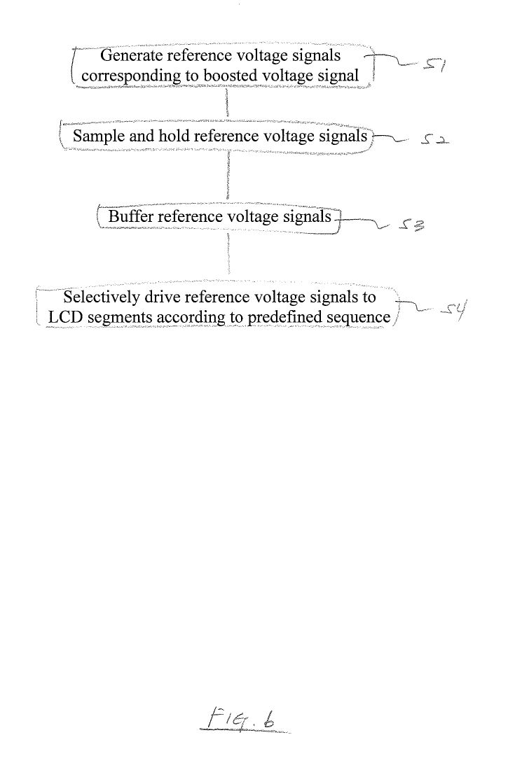

Turning now to FIG. 6, an exemplary flow chart for driving an LCD 12 having a plurality of segments 13 is disclosed. As shown, the method for driving segments 13 of an LCD 12 may essentially include steps S1-S4. For instance, in a step S1, a reference module 18 may be used to generate a plurality of duty cycled reference voltages. The duty cycled reference voltages may be sampled and held in a step S2. In a further step S3, the duty cycled reference voltages may be buffered using adaptively biased buffers, or the like. Furthermore, the buffered reference voltages may be driven to the respective segments 13 of the LCD 12 according to a predefined sequence in a step S4. Particularly, the predefined sequence may be timed such that the voltages received across each segment 13 appear to have an RMS voltage that is either greater than a predefined threshold voltage of the segment 13 to enable the segment 13, or is less than the predefined threshold voltage of the segment 13 to disable the segment 13.

### INDUSTRIAL APPLICABILITY

In satisfaction of the above-identified needs, an improved LCD driver is disclosed that collectively incorporates and integrates various energy saving techniques and strategies to provide optimum performance at minimum power. The LCD driver accomplishes this by providing duty cycled references and an adaptively biased output stage to the segments of an LCD. The disclosed LCD driver includes a control module, a power supply module, a reference module and a selector module. Moreover, each of the modules of the LCD driver are configured so as to occupy less on-chip space, consume only a fraction of the current required by typical low power LCD drivers, and prevent LCD segment degradation.

While only certain embodiments have been set forth, alternatives and modifications will be apparent from the above description to those skilled in the art. These and other alternatives are considered equivalents and within the spirit and scope of this disclosure and the appended claims.

What is claimed:

1. A liquid crystal display (LCD) driver for providing at least one duty cycled reference voltage and an adaptively biased output stage for driving an LCD having a plurality of segments, comprising:
one or more control modules configured to output at least a clock, a first control, a second control and a third control;
one or more power supply modules configured to receive a supply voltage and the first control, and further configured to output the supply voltage;
one or more reference modules configured to receive the supply voltage provided by the power supply module and the second control, the reference module being configured to output a plurality of buffered reference voltages; and
one or more selector modules configured to receive the buffered reference voltages and the third control, the selector module being configured to output one or more of the buffered reference voltages to one or more of the segments of the LCD according to a predefined sequence.

2. The LCD driver of claim 1, wherein the reference module includes a duty cycled resistor ladder.

3. The LCD driver of claim 1, wherein the reference module includes a capacitive digital-to-analog converter (DAC).

4. The LCD driver of claim 1, wherein the reference module includes one or more adaptively biased buffers.

5. The LCD driver of claim 1, wherein the power supply module is configured to make no adjustments to the supply voltage received.

6. The LCD driver of claim 1, wherein the power supply module is configured to at least regulate, buck, or boost the supply voltage received.

7. The LCD driver of claim 6, wherein the power supply module includes at least one storage device and one or more switches configured to selectively charge or discharge the storage device.

8. The LCD driver of claim 7, wherein the storage device is a capacitor.

9. The LCD driver of claim 7, wherein the power supply module includes at least one comparator configured to compare a magnitude of the supply voltage to a magnitude of an output of the power supply module.

10. The LCD driver of claim 7, wherein the power supply module is configured to discharge the storage device and boost the supply voltage only when the magnitude of the supply voltage is less than the magnitude of the output of the power supply module.

11. The LCD driver of claim 7, wherein the power supply module includes a clock generator configuration for charging the storage device.

12. The LCD driver of claim 1, wherein the selector module includes a plurality of substantially small multiplexers.

13. The LCD driver of claim 12, wherein the multiplexers are configured such that each multiplexer is associated with a pad interfacing with the segments of the LCD.

14. The LCD driver of claim 12, wherein the selector module includes a digital control bus for transmitting the third control to each of the multiplexers.

15. A method for driving a liquid crystal display (LCD) having a plurality of segments, comprising the steps of:
providing a clock and a supply voltage;
generating a plurality of reference voltages;
maintaining the reference voltages by duty cycling;
buffering the reference voltages; and
selectively driving the reference voltages to the segments of the LCD according to a predefined sequence.

16. The method of claim 15, wherein the reference voltages are generated using a duty cycled configuration of resistors.

17. The method of claim 15, wherein the reference voltages are generated using a capacitive digital-to-analog converter (DAC).

18. The method of claim 15, wherein the reference voltages are selectively driven to the segments of the LCD via a plurality of substantially small multiplexers.

19. The method of claim 18, wherein the multiplexers are configured such that each multiplexer is associated with a pad interfacing with the segments of the LCD.

20. The method of claim 15 further comprising the step of generating a boosted voltage employing at least one capacitor and one or more switches configured to selectively charge or discharge the capacitor.

21. The method of claim 20, wherein the step of generating a boosted voltage employs a comparator to compare a magnitude of the supply voltage to a magnitude of the boosted voltage, and discharges the capacitor to boost the supply voltage only when the magnitude of the supply voltage is less than the magnitude of the boosted voltage.
